(19) United States
(12) Patent Application Publication
(10) Pub. No.: US 2025/0102963 A1
(43) Pub. Date: Mar. 27, 2025

(54) DEVELOPING DEVICE AND IMAGE FORMING APPARATUS

(71) Applicant: FUJIFILM Business Innovation Corp., Tokyo (JP)

(72) Inventors: Shigeru INABA, Kanagawa (JP); Hirokazu MUKAI, Kanagawa (JP)

(73) Assignee: FUJIFILM Business Innovation Corp., Tokyo (JP)

(21) Appl. No.: 18/582,678

(22) Filed: Feb. 21, 2024

(30) Foreign Application Priority Data
Sep. 26, 2023 (JP) 2023-163961

(51) Int. Cl. G03G 15/09

(52) U.S. Cl. CPC G03G 15/0921

(57) ABSTRACT

A developing device includes a developer holder that holds a developer containing toner and carrier and being supplied to an image holder forming an electrostatic latent image; a first member that is provided on a downstream side of a developing position that is a position where the developer held by the developer holder is supplied to the image holder; and a second member that is provided between the developer holder, the image holder, and the first member, that has a surface facing the developer holder, and to which an intermediate potential as a potential between a potential applied to the developer holder and a potential applied to the first member is applied.

### CROSS-REFERENCE TO RELATED APPLICATIONS

This application is based on and claims priority under 35 USC 119 from Japanese Patent Application No. 2023-163961 filed Sep. 26, 2023.

### BACKGROUND

### (i) Technical Field

The present invention relates to a developing device and an image forming apparatus.

### (ii) Related Art

For example, JP1994-11970A discloses a developing apparatus of an image forming apparatus that includes a development magnetic pole; and at least one conveyance magnetic pole arranged on the downstream side of the development magnetic pole, in which, using a developer carrier in which the polarity of the conveyance magnetic pole adjacent to the development magnetic pole is different from the polarity of the development magnetic pole, a magnetic brush of a two-component developer containing toner and carrier as main components is formed on the developer carrier to develop an electrostatic latent image formed on a photoreceptor, a member for collecting the carrier separated from the developer carrier is provided close to the conveyance magnetic pole adjacent to the development magnetic pole, and a magnetic pole having the identical polarity as the development magnetic pole is provided inside the carrier collecting member.

### SUMMARY

Here, in a case of collecting floating toner inside a developing device to prevent the floating toner from leaking to the outside, since the floating toner includes normal electrode toner and reverse polarity toner which have different magnetic poles, an electric field used to collect the normal electrode toner cannot collect the reverse polarity toner, which is difficult to efficiently collect the floating toner.

Aspects of non-limiting embodiments of the present disclosure relate to a developing device and an image forming apparatus that efficiently collect the floating toner in the developing device as compared with a case where an electric field is provided that collects the normal electrode toner but does not collect the reverse polarity toner.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a developing device including a developer holder that holds a developer containing toner and carrier and being supplied to an image holder forming an electrostatic latent image; a first member that is provided on a downstream side of a developing position that is a position where the developer held by the developer holder is supplied to the image holder; and a second member that is provided between the developer holder, the image holder, and the first member, that has a surface facing the developer holder, and to which an intermediate potential as a potential between a potential applied to the developer holder and a potential applied to the first member is applied.

### BRIEF DESCRIPTION OF THE DRAWINGS

Exemplary embodiment(s) of the present invention will be described in detail based on the following figures, wherein:

FIG. 1 is a diagram illustrating an image forming apparatus;

FIG. 2 is a diagram illustrating a developing device of the image forming apparatus;

FIGS. 3A to 3C are diagrams illustrating a developing device according to a first exemplary embodiment, FIG. 3A illustrates the developing device together with a photosensitive drum, FIG. 3B illustrates an electrode member alone, and FIG. 3C illustrates a positional relationship between a seal roll and the electrode member;

FIG. 4 is a diagram illustrating an action of a potential applied to the electrode member according to the first exemplary embodiment;

FIG. 5 is a diagram illustrating an action of a potential applied to the electrode member according to a comparative example;

FIG. 6 is a diagram illustrating a case where a developer held by a developing roll comes into contact with the seal roll;

FIG. 7 is a diagram illustrating a magnetic field of a developer layer held by the developing roll;

FIG. 8 is a diagram illustrating a magnetic brush of the developer layer held by the developing roll;

FIGS. 9A and 9B are diagrams illustrating modification examples of the electrode member according to the first exemplary embodiment, FIG. 9A is one modification example, and FIG. 9B is another modification example; and

FIG. 10 is a diagram illustrating a developing device according to a second exemplary embodiment.

### DETAILED DESCRIPTION

Hereinafter, exemplary embodiments of the invention will be described in detail with reference to the accompanying drawings.

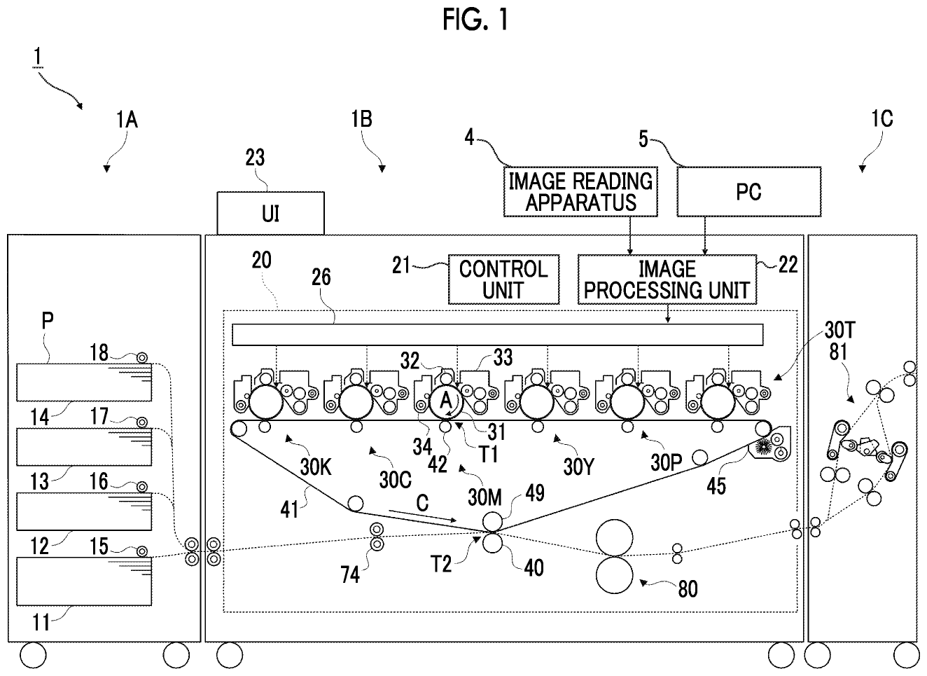

FIG. 1 is a diagram illustrating an image forming apparatus 1.

The image forming apparatus 1 according to the present exemplary embodiment includes a paper feeding unit 1A, a printing unit 1B, and a paper discharge unit 1C.

The paper feeding unit 1A includes a first paper accommodation portion 11 to a fourth paper accommodation portion 14 that accommodate paper P as an example of a recording medium.

In addition, the paper feeding unit 1A is provided with feeding rolls 15 to 18 that are provided respectively corresponding to the first paper accommodation portion 11 to the fourth paper accommodation portion 14, and that feed the paper P accommodated in each paper accommodation portion to a conveyance route connected to the printing unit 1B.

The printing unit 1B includes an image forming portion 20 that forms an image on the paper P. In addition, the printing unit 1B is provided with a control unit 21 that controls each unit of the image forming apparatus 1.

In addition, the printing unit 1B also includes an image processing unit 22. The image processing unit 22 performs image processing on image data transmitted from an image reading apparatus 4 and a personal computer (PC) 5.

In addition, the printing unit 1B is provided with a user interface (UI) 23 that is configured by a touch panel or the like and that notifies a user of information and receives an input of information from the user.

The image forming portion 20 as an example of an image forming section is provided with six image forming units 30T, 30P, 30Y, 30M, 30C, and 30K (hereinafter simply referred to as “image forming unit 30”) arranged in parallel at regular intervals.

Each image forming unit 30 includes a photosensitive drum 31 on which an electrostatic latent image is formed while rotating in a direction of arrow A, a charging roll 32 that charges a surface of the photosensitive drum 31, a developing device 33 that develops the electrostatic latent image formed on the photosensitive drum 31, and a drum cleaner 34 that removes toner or the like on the surface of the photosensitive drum 31.

The photosensitive drum 31 is an example of an image holder.

In addition, the image forming portion 20 is provided with a laser exposure device 26 that exposes each photosensitive drum 31 of each image forming unit 30 with laser light.

Note that the exposure of the photosensitive drum 31 by the laser exposure device 26 is not limited to using laser light. For example, each image forming unit 30 may be provided with a light source such as a light emitting diode (LED), and the exposure of the photosensitive drum 31 may be performed using light emitted from the light source.

The respective image forming units 30 have a similar configuration except for the toner housed in the developing device 33. The image forming units 30Y, 30M, 30C, and 30K form yellow (Y), magenta (M), cyan (C), and black (K) toner images, respectively.

In addition, the image forming units 30T and 30P form toner images using toner corresponding to corporate colors, foamed toner for braille, fluorescent toner, toner to improve glossiness, and the like. In other words, the image forming units 30T and 30P form toner images using special color toner.

In addition, the image forming portion 20 is provided with an intermediate transfer belt 41 to which the toner image of each color formed on the photosensitive drum 31 of each image forming unit 30 is transferred.

In addition, the image forming portion 20 is provided with a primary transfer roll 42 that transfers each color toner image of each image forming unit 30 onto the intermediate transfer belt 41 at a primary transfer portion T1.

In addition, the image forming portion 20 is provided with a secondary transfer roll 40 that transfers the toner images transferred onto the intermediate transfer belt 41 all at once onto the paper P at a secondary transfer portion T2.

Further, the image forming portion 20 is provided with a belt cleaner 45 that removes toner or the like on the surface of the intermediate transfer belt 41, and a fixing device 80 that fixes the secondarily transferred image onto the paper P.

The developing device 33 is an example of a developing section, the intermediate transfer belt 41 is an example of a transfer section, and the fixing device 80 is an example of a fixing section.

The image forming portion 20 performs an image forming operation on the basis of a control signal from the control unit 21.

Specifically, in the image forming portion 20, first, image processing is performed by the image processing unit 22 on the image data input from the image reading apparatus 4 or the PC 5, and the image data after the image processing is performed is supplied to the laser exposure device 26.

Then, for example, in the image forming unit 30M for magenta (M), after the surface of the photosensitive drum 31 is charged by the charging roll 32, the photosensitive drum 31 is irradiated by the laser exposure device 26 with the laser light modulated with the image data obtained from the image processing unit 22.

In this manner, the electrostatic latent image is formed on the photosensitive drum 31.

The formed electrostatic latent image is developed by the developing device 33, and a magenta toner image is formed on the photosensitive drum 31.

Similarly, in the image forming units 30Y, 30C, and 30K, yellow, cyan, and black toner images are formed, and in the image forming units 30T and 30P, special color toner images are formed.

Each color toner image formed in each image forming unit 30 is sequentially electrostatically transferred by the primary transfer roll 42, onto the intermediate transfer belt 41 that rotates in a direction of arrow C in FIG. 1, and superimposed toner images are formed on the intermediate transfer belt 41.

The superimposed toner images formed on the intermediate transfer belt 41 are conveyed to the secondary transfer portion T2 that is configured by the secondary transfer roll 40 and a backup roll 49, as the intermediate transfer belt 41 is moved.

On the other hand, the paper P is taken out from the first paper accommodation portion 11 by, for example, the feeding roll 15, and then is conveyed to a position of a registration roll 74 via the conveyance route.

In a case where the superimposed toner images are conveyed to the secondary transfer portion T2, the paper P is supplied from the registration roll 74 to the secondary transfer portion T2 at the same time.

Then, at the secondary transfer portion T2, the superimposed toner images are electrostatically transferred all at once onto the paper P by the action of a transfer electric field formed between the secondary transfer roll 40 and the backup roll 49.

Thereafter, the paper P on which the superimposed toner images have been electrostatically transferred is conveyed to the fixing device 80.

In the fixing device 80, the paper P on which the unfixed toner image is formed is pressurized and heated, and fixing processing of the toner image on the paper P is performed.

Then, the paper P on which the fixing processing has been performed is conveyed to a paper stacking portion (not illustrated) after passing through a curl correction portion 81 provided in the paper discharge unit 1C.

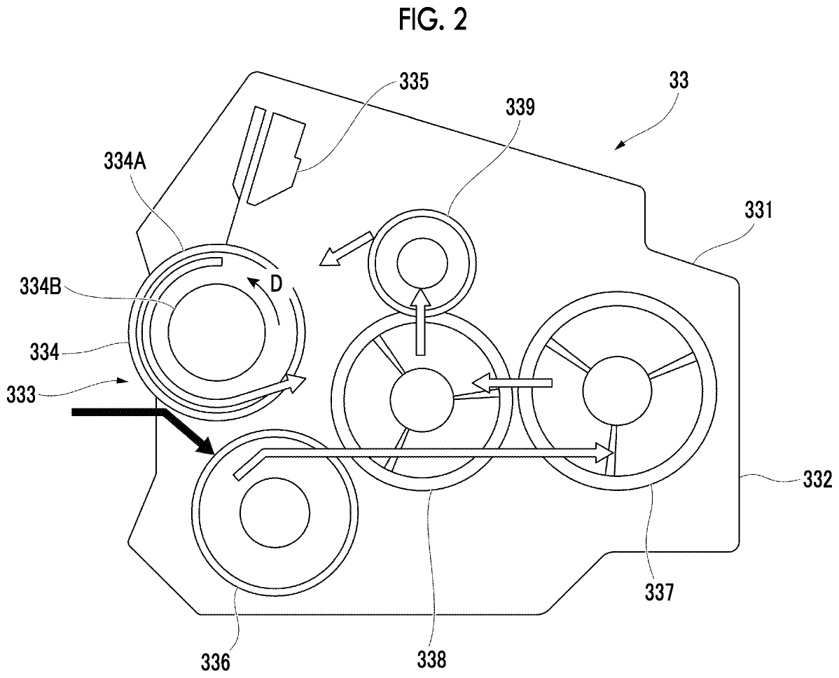

FIG. 2 is a diagram illustrating the developing device 33 of the image forming apparatus 1.

The developing device 33 includes an accommodation portion 331 that accommodates a developer (not illustrated) therein. The accommodation portion 331 is configured by an accommodation case 332 made of resin. Such a developer is configured by magnetic carrier and colored toner, and is a so-called two-component developer.

The accommodation case 332 of the developing device 33 is arranged to extend along a direction perpendicular to the paper surface of FIG. 2, which is a direction from the front side to the rear side of the image forming apparatus 1 (refer to FIG. 1), and has a front side member (not illustrated) on the front side and a rear side member (not illustrated) on the rear side.

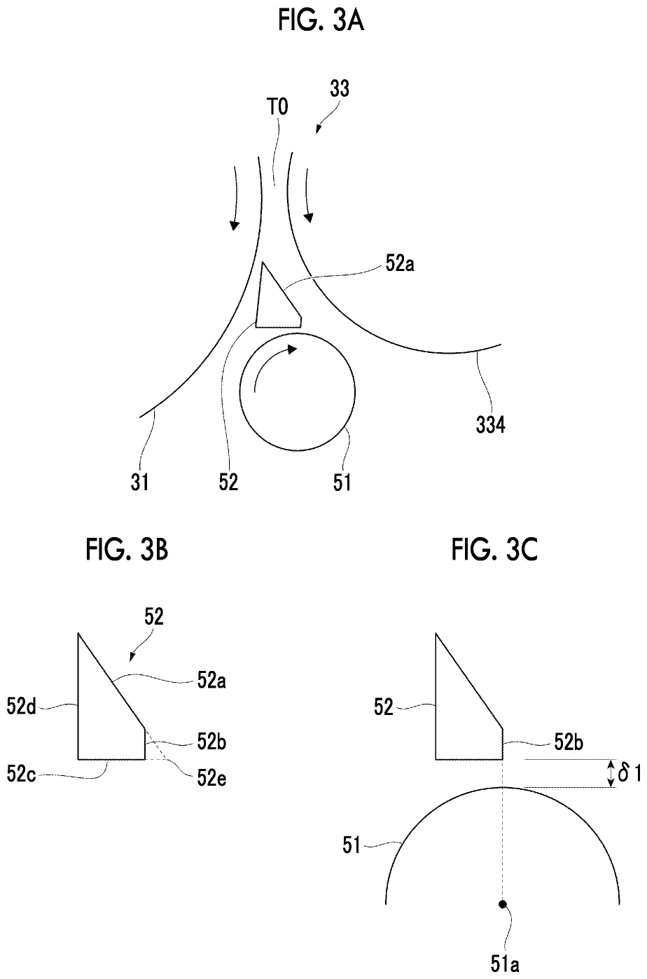

The accommodation case 332 is provided with an opening portion 333 at a location facing the photosensitive drum 31 (refer to FIG. 1). A developing roll 334 that causes the developer to adhere to the surface of the photosensitive drum 31 is provided in the opening portion 333. The developing roll 334 holds the developer to be supplied to the photosensitive drum 31. A position at which the developer of the developing roll 334 is supplied to the photosensitive drum 31 is sometimes referred to as a developing position T0 (for example, refer to FIGS. 3A to 3C).

The developing roll 334 as an example of the developer holder is formed in a cylindrical shape, and is arranged to extend along the direction from the front side to the rear side of the image forming apparatus 1. Additionally, the developing roll 334 is arranged along a longitudinal direction of the developing device 33.

The developing roll 334 is provided with a developing sleeve 334A that is configured by a cylindrical body and is rotationally driven, and with a magnet roll 334B arranged on the inner side of the developing sleeve 334A.

The developing sleeve 334A is configured by metal such as SUS, for example. In addition, the developing sleeve 334A rotates in a direction of arrow D in the figure.

The developing roll 334 is an example of the developer holder.

Further, in the present exemplary embodiment, the developing sleeve 334A and the photosensitive drum 31 rotate such that the developing sleeve 334A and the photosensitive drum 31 are moved in the same direction at the primary transfer portion T1 (refer to FIG. 1) between the developing roll 334 and the photosensitive drum 31.

The developing device 33 is provided with a layer regulating member 335 that regulates a layer thickness of the developer held on the developing roll 334.

In addition, as illustrated in FIG. 2, the developing device 33 is provided with a first conveyance member 336 and a second conveyance member 337 that convey the developer.

The first conveyance member 336 and the second conveyance member 337 are provided on a side opposite to the side where the photosensitive drum 31 (refer to FIG. 1) is installed with respect to the developing roll 334.

The first conveyance member 336 includes a rotation axis along a rotation axis of the developing sleeve 334A that is rotationally driven, rotates around the rotation axis, and conveys the developer in the accommodation portion 331.

In the developing device 33 configured as described above, new toner or toner to which a very small amount of carrier is added is conveyed in circulation by being agitated and conveyed between the first conveyance member 336 and the second conveyance member 337. More specifically, by delivering the developer through connection ports formed at both ends of a partition wall extending in an axial direction, the developer agitated by the first conveyance member 336 is agitated by the second conveyance member 337, and can be further agitated by the first conveyance member 336. In the developing device 33, circulation routes as routes circulating in the axial direction due to the rotation of each of the first conveyance member 336 and the second conveyance member 337 are formed.

In the developing device 33, a third conveyance member 338 adjacent to the second conveyance member 337 is provided. In addition, in the developing device 33, a pickup roll 339 positioned above the third conveyance member 338 is provided.

The conveyance route formed by the rotation of the third conveyance member 338 is connected to the above-mentioned circulation route, and the developer from the circulation route is delivered. The third conveyance member 338 supplies the developer to the pickup roll 339. The pickup roll 339 supplies the developer to the developing roll 334.

For example, the first conveyance member 336 performs the conveyance to the front side of the page, the second conveyance member 337 performs the conveyance to the back side of the page, and the third conveyance member 338 performs the conveyance to the front side of the page.

Note that the developing roll 334, the layer regulating member 335, the first conveyance member 336, the second conveyance member 337, the third conveyance member 338, and the pickup roll 339 are arranged substantially parallel to the photosensitive drum 31 (refer to FIG. 1).

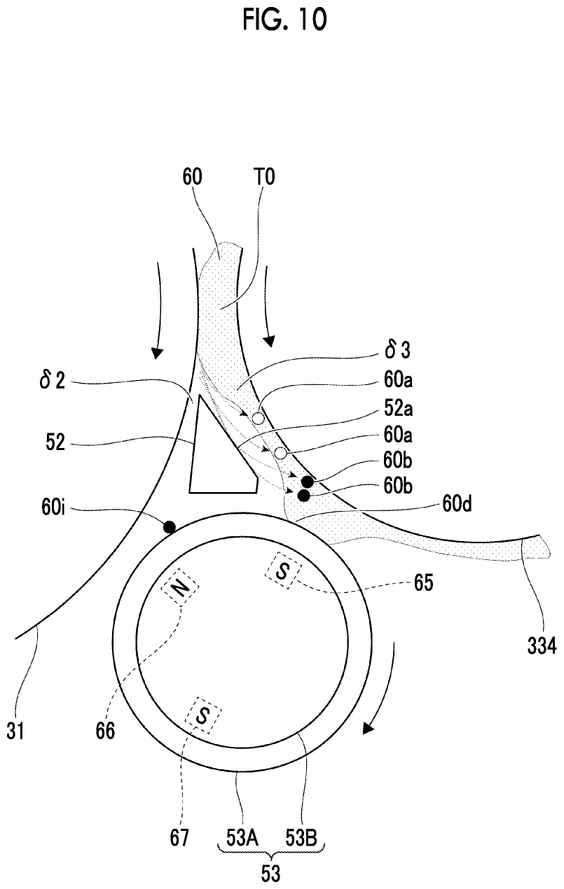

Next, a more specific configuration of the developing device 33 will be described. As such specific configurations, a first exemplary embodiment and a second exemplary embodiment will be described. The developing device 33 according to the first exemplary embodiment includes a seal roll 51 as an example of a first member (for example, refer to FIGS. 3A to 3C). In addition, the developing device 33 according to the second exemplary embodiment includes a carrier collection roll 53 as an example of the first member (refer to FIG. 10).

FIGS. 3A to 3C are diagrams illustrating the developing device 33 according to the first exemplary embodiment, FIG. 3A illustrates the developing device 33 together with the photosensitive drum 31, FIG. 3B illustrates an electrode member 52 alone, and FIG. 3C illustrates a positional relationship between the seal roll 51 and the electrode member 52.

As illustrated in FIG. 3A, the developing device 33 includes the seal roll 51 provided to face the photosensitive drum 31 and the developing roll 334, and the electrode member 52 provided to be surrounded by the photosensitive drum 31, the developing roll 334, and the seal roll 51. The seal roll 51 is an example of the first member, and the electrode member 52 is an example of a second member.

The seal roll 51 is positioned on the downstream side of the developing position T0 where the developer of the developing roll 334 is supplied to the photosensitive drum 31, and rotates in a clockwise direction that is a direction opposite to a counterclockwise direction in which the developing roll 334 rotates. The seal roll 51 has a smaller diameter than the diameters of the photosensitive drum 31 and the developing roll 334.

The downstream side here refers to a downstream side in the rotation direction of the photosensitive drum 31 or the developing roll 334 with respect to the developing position T0.

Unlike the seal roll 51, the electrode member 52 is a fixed member. In addition, in the present exemplary embodiment, the electrode member 52 has a shape based on a triangular shape that can be accommodated in a space formed by the developing roll 334, the photosensitive drum 31, and the seal roll 51, as illustrated in FIG. 3A. The space here is a region surrounded by tangents of the developing roll 334, the photosensitive drum 31, and the seal roll 51, and is an example of a region between the developer holder the image holder, and the first member.

In more detail, the electrode member 52 has a surface 52a facing the developing roll 334 between the developing roll 334, the photosensitive drum 31, and the seal roll 51. The surface 52a is an example of a surface facing the developer holder, and is an example of a slope.

To describe the electrode member 52 in more detail, as illustrated in FIG. 3B, the electrode member 52 has the above-mentioned surface 52a, a surface 52b that is formed at a position adjacent to the surface 52a to face the developing roll 334, a surface 52c that is formed at a position adjacent to the surface 52b to face the seal roll 51, and a surface 52d that is formed at a position adjacent to the surfaces 52c and 52a to face the photosensitive drum 31.

The surface 52a of the electrode member 52 is provided in a tangential direction of the developing roll 334 so that the distance from the developing roll 334 is not changed from an upstream end portion to a downstream end portion of the surface 52a. Note that the surface 52a may be provided in a direction other than the tangential direction.

In addition, the electrode member 52 has a polygonal shape in which the surface 52b is formed by cutting out one corner 52e near the developing roll 334 and the seal roll 51 in the triangular shape.

The surface 52b of the electrode member 52 is an example of a surface facing the developer holder.

In more detail, as illustrated in FIG. 3C, the surface 52b of the electrode member 52 is provided at a position adjacent to the seal roll 51, and extends in a direction toward a center 51a of the seal roll 51. In this manner, the electrode member 52 is arranged such that a gap δ1 between the electrode member 52 and the seal roll 51 is small.

Note that the surface 52b is not limited to the case of extending in the direction toward the center 51a of the seal roll 51, and may be configured to extend in other directions. It is preferable that the other directions here are, for example, directions that become closer to the seal roll 51 as the surface 52b approaches the seal roll 51.

Next, the potential applied to the electrode member 52 will be described.

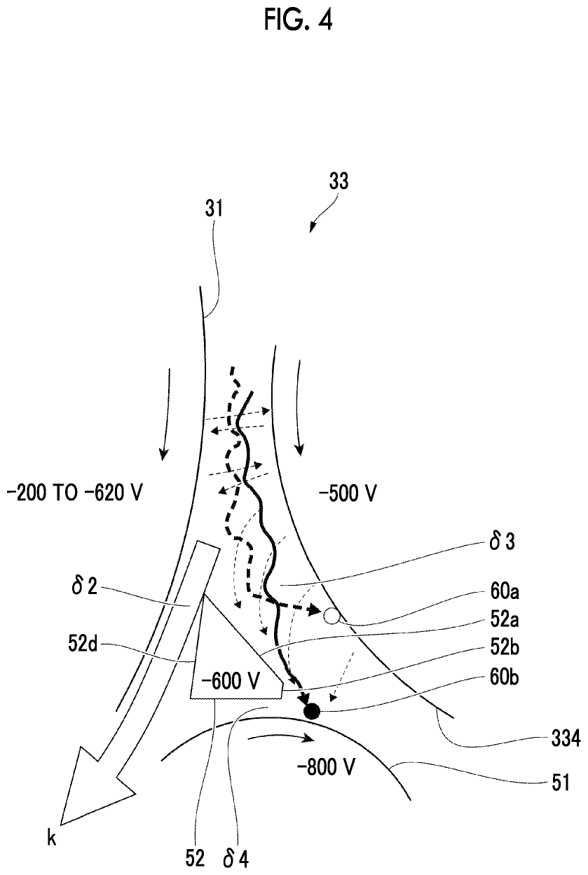

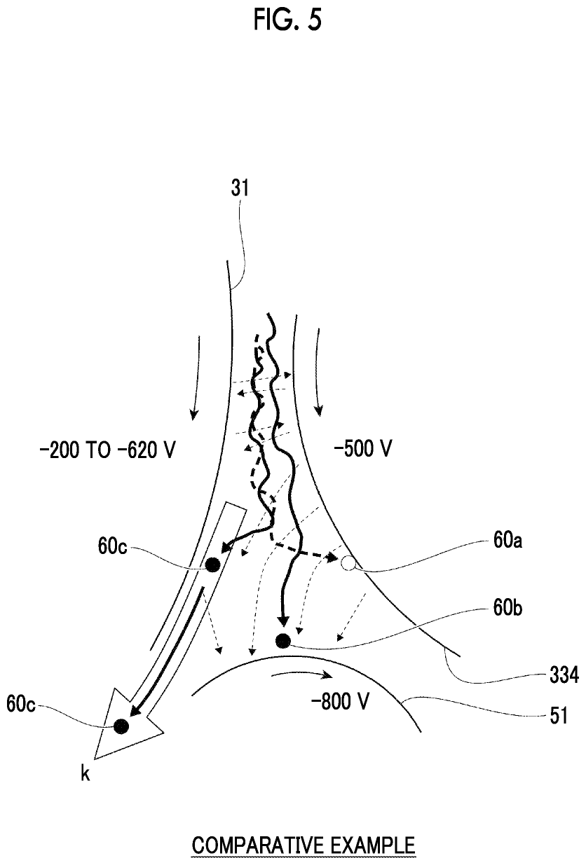

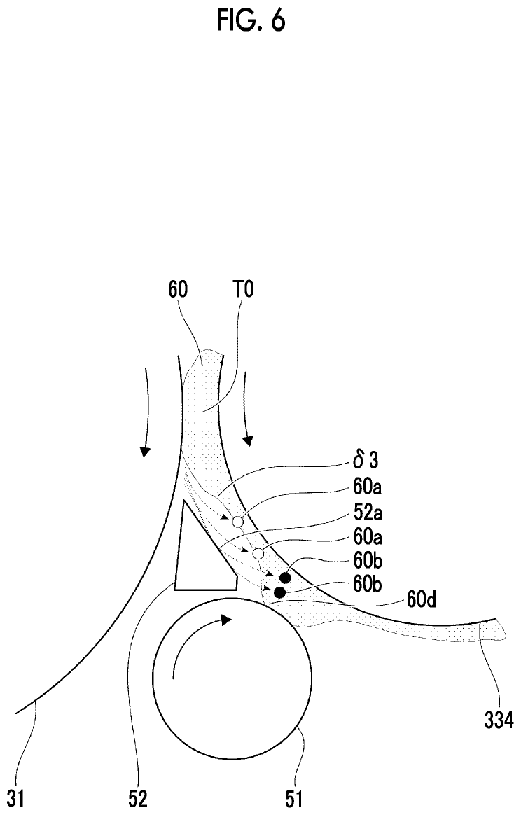

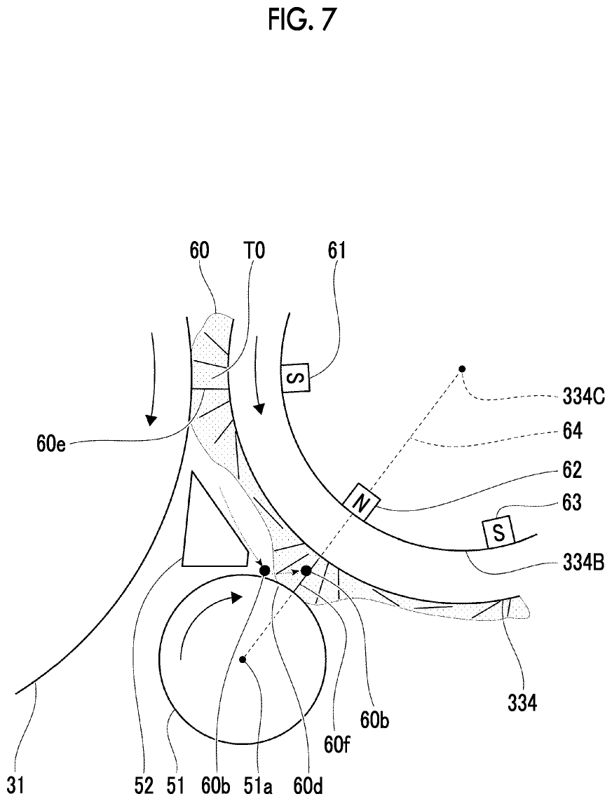

FIGS. 4 and 5 are diagrams illustrating an action of the potential applied to the electrode member 52, FIG. 4 illustrates a case of the first exemplary embodiment, and FIG. 5 illustrates a comparative example. Note that in FIGS. 4 and 5, the direction of the electric field is indicated by thin dashed arrows. In addition, in FIGS. 4 and 5, illustration of a developer layer 60 illustrated in FIGS. 6 and 7, which will be described later, is omitted for convenience of description.

In the present exemplary embodiment, as illustrated in FIG. 4, a potential of −500 V is applied to the developing roll 334, and a potential of −800 V is applied to the seal roll 51. A potential of −600 V, which is an intermediate potential between the potential of the developing roll 334 and the potential of the seal roll 51, is applied to the electrode member 52. In this manner, an electric field that collects the floating toner is formed.

The power supply to the electrode member 52 can be divided from the power supply of the seal roll 51.

Note that the photosensitive drum 31 has a potential of −200 to −620 V. More specifically, a part of the photosensitive drum 31 where the electrostatic latent image is formed has a potential of −200 V, and a part of the photosensitive drum 31 where the electrostatic latent image is not formed has a potential of −620 V.

Hereinafter, the formation of the electric field that collects the floating toner will be described.

In a case of adopting the above-mentioned relationship of applied potentials, focusing on the developing roll 334 and the electrode member 52, the positive (+) side is the developing roll 334. On the other hand, in a case of focusing on the electrode member 52 and the seal roll 51, the positive (+) side is the electrode member 52.

In addition, the above-mentioned floating toner may include normal electrode toner 60a (indicated by a white circle) which is negatively charged (−), and reverse electrode toner 60b (indicated by a black circle) which is positively charged (+). Although it is assumed that the floating toner does not include the reverse electrode toner 60b, the reverse electrode toner 60b may be included.

In a case of comparing the amounts of the normal electrode toner 60a and the reverse electrode toner 60b in the floating toner, the amount of the normal electrode toner 60a is greater than the amount of the reverse electrode toner 60b, the ratio thereof fluctuates depending on the decrease in the charge amount and deterioration of the developer due to various conditions such as the ratio of toner in the developer or the like, and a case where the reverse electrode toner 60b is included in about 10% of the floating toner can be described as an example.

Here, in accordance with the rotation of the photosensitive drum 31 and the developing roll 334, an airflow from the developing position T0 (refer to FIG. 6) to the downstream side is generated, and thus the floating toner moves by riding on the airflow. More specifically, since the electrode member 52 is positioned on the downstream side of the developing position T0, the airflow includes an airflow passing between the photosensitive drum 31 and the electrode member 52 and an airflow passing between the developing roll 334 and the electrode member 52. In more detail, in the first exemplary embodiment, in a case of comparing a gap δ2 between the photosensitive drum 31 and the electrode member 52 and a gap δ3 between the developing roll 334 and the electrode member 52, the gap δ2 is smaller than the gap δ3 (δ2<δ3). Therefore, the amount of airflow passing through the gap δ3 is large, and the amount of airflow passing through the gap δ2 is small. In addition, the surface 52a of the electrode member 52 faces toward the developing roll 334 to block the airflow passing through the gap 82 and to promote the airflow passing through the gap δ3.

In addition, by applying the intermediate potential to the electrode member 52 described above, the normal electrode toner 60a in the floating toner is drawn toward the developing roll 334 by the action of repelling the electrode member 52 and being attracted to the developing roll 334, as indicated by a thick dashed arrow. In addition, the reverse electrode toner 60b is drawn toward the electrode member 52 by the action of repelling the developing roll 334 and being attracted to the electrode member 52, as indicated by a thick solid arrow.

Due to the action of the intermediate potential of the electrode member 52, the floating toner moves by riding on the airflow passing through the gap 83.

Note that a case will be described in which a smaller amount of reverse electrode toner 60b than the normal electrode toner 60a rides on the airflow passing through the gap δ2. Focusing on the photosensitive drum 31 and the electrode member 52, since the positive (+) side is the photosensitive drum 31, the reverse electrode toner 60b repels the photosensitive drum 31 and is attracted to the electrode member 52. In this manner, it is assumed that the reverse electrode toner 60b is drawn to the electrode member 52 and adheres to, for example, the surface 52d.

In the floating toner that moves by riding on the airflow passing through the gap δ3, the negatively charged normal electrode toner 60a is drawn toward the developing roll 334 between the developing roll 334 and the electrode member 52, while the positively charged reverse electrode toner 60b repels the developing roll 334 and is drawn toward the electrode member 52.

In addition, the positively charged reverse electrode toner 60b that has been drawn toward the electrode member 52 is drawn toward the seal roll 51. In addition, the surface 52b of the electrode member 52 extends in a center direction of the seal roll 51 such that a gap δ4 between the electrode member 52 and the seal roll 51 does not become large.

Therefore, the reverse electrode toner 60b drawn to the electrode member 52 is prevented from riding on the airflow passing through the gap δ2 from the gap δ4.

Note that it is assumed that, even in a case where the reverse electrode toner 60b moves by riding on the airflow passing through the gap δ2, the reverse electrode toner 60b is drawn to the electrode member 52 and adheres to, for example, the surface 52d. In this manner, the amount of the reverse electrode toner 60b leaking to the outside of the device by riding on the airflow (arrow k illustrated in FIG. 4) passing through the gap δ2 is suppressed.

In addition, the size relationship of the gaps δ1 to δ4 is not limited to that described above, and the gaps δ1 to δ4 may have a size relationship different from the size relationship described above.

Here, a setting method of the intermediate potential applied to the electrode member 52 as an example of the second member will be described.

In the present exemplary embodiment, as described above, a potential of −500 V is applied to the developing roll 334, a potential of −800 V is applied to the seal roll 51, and a potential of −600 V is applied as the intermediate potential to the electrode member 52. Due to this intermediate potential, the potential difference between the developing roll 334 and the electrode member 52 is 100 V, and the potential difference between the seal roll 51 and the electrode member 52 is 200 V. However, such a potential difference is not limited thereto.

For example, it is conceivable to associate the size relationship of the potential differences with the size relationship of the gaps.

The gap 83 between the developing roll 334 and the electrode member 52 and the gap δ4 between the electrode member 52 and the seal roll 51 may be compared, and the potential difference of the closer one may be set to be smaller than the potential difference of the far one. More specifically, in the present exemplary embodiment, as illustrated in FIG. 4, since the gap δ4 is smaller than the gap δ3 (δ4<δ3), the potential difference between the electrode member 52 and the seal roll 51 is set to be smaller than the potential difference between the developing roll 334 and the electrode member 52. That is, in this case, the intermediate potential applied to the electrode member 52 is, for example, −700 V.

Note that the gap δ3 in this case is the shortest distance between the developing roll 334 and the electrode member 52, and the gap δ4 refers to a position 60d (refer to FIG. 6) closest to the electrode member 52 among the contact positions in a case where the developer layer 60 held by the developing roll 334 comes into contact with the seal roll 51 (refer to FIG. 6). The position 60d here is a position of the upstream end of the developer layer 60 in contact with the seal roll 51 in the rotational direction of the seal roll 51.

The gap δ3 described above is an example of the distance between the second member and the developer holder, and the gap δ4 is an example of the distance between the second member and the first member.

In addition, as another setting method of the intermediate potential, it is conceivable to set the potential difference according to the ratio of gaps. For example, a ratio between the gap δ3 and the gap δ4 is obtained, and the intermediate potential is set by dividing the ratio proportionally. More specifically, in a case where the potential difference between the developing roll 334 and the seal roll 51 is 300 V and the ratio between the gap δ3 and the gap δ4 is 5:1, the potential difference for the gap δ3 is 250 V, and the potential difference for the gap δ4 is 50 V. That is, in this case, the intermediate potential applied to the electrode member 52 is −750 V.

Here, a comparative example with respect to the first exemplary embodiment will be described

As such a comparative example, a configuration in which the electrode member 52 illustrated in FIG. 4 is not included is illustrated in FIG. 5. In the comparative example illustrated in FIG. 5, the configuration other than the configuration in which the electrode member 52 is not included is the same as in the case of FIG. 4, and the use of the thick solid arrow, the thick dashed arrow, the thin dashed arrow, and the arrow k is the same as in the case of FIG. 4. Note that, for convenience of description, in addition to the normal electrode toner 60a and the reverse electrode toner 60b illustrated in FIG. 4, reverse electrode toner 60c not illustrated in FIG. 4 is illustrated in FIG. 5.

In the comparative example illustrated in FIG. 5, the normal electrode toner 60a is drawn to the developing roll 334, the reverse electrode toner 60b is drawn to the seal roll 51, and the reverse electrode toner 60c moves by riding on the airflow passing between the photosensitive drum 31 and the seal roll 51. In this manner, the reverse electrode toner 60c leaks to the outside of the device, and the amount of leakage is not suppressed.

On the other hand, in the first exemplary embodiment illustrated in FIG. 4, as described above, by applying the intermediate potential to the electrode member 52 having the surface 52a facing the developing roll 334, the amount of the reverse electrode toner 60b leaking to the outside of the device is suppressed.

FIG. 6 is a diagram illustrating a case where the developer held by the developing roll 334 comes into contact with the seal roll 51.

The developer layer 60 held by the developing roll 334 is illustrated in FIG. 6. The developer layer 60 comes into contact with the photosensitive drum 31 at the developing position T0, and also comes into contact with the seal roll 51 at a position on the downstream side thereof. That is, the space between the developing roll 334 and the seal roll 51 is closed by the developer layer 60.

Therefore, the normal electrode toner 60a and the reverse electrode toner 60b as the floating toner that moves by riding on the airflow passing through the gap δ3 between the developing roll 334 and the electrode member 52 are collected by the developer layer 60. In this manner, the leakage of the floating toner to the outside of the developing device 33 is suppressed.

Note that FIG. 6 illustrates a state in which the developer layer 60 comes into contact with the seal roll 51, but the present invention is not limited thereto, and the developer layer 60 may not come into contact with the seal roll 51.

FIG. 7 is a diagram illustrating a magnetic field of the developer layer 60 held by the developing roll 334.

As illustrated in FIG. 7, the magnet roll 334B of the developing roll 334 is provided with a plurality of magnetic poles arranged along a circumferential direction. More specifically, the magnet roll 334B is provided with, as the plurality of magnetic poles, for example, an S pole 61 at a position corresponding to the developing position T0, and an N pole 62 is provided at a position facing the seal roll 51 on the downstream side thereof. Further, an S pole 63 is provided on the downstream side.

Due to the plurality of magnetic poles, the layer thickness of the developer layer 60 is changed depending on the position in the circumferential direction. In other words, the layer thickness in contact with the photosensitive drum 31 is formed by the S pole 61, and the layer thickness in contact with the seal roll 51 is formed by the N pole 62.

In more detail, magnetic lines of force are formed by the magnetic field of the developer layer 60. More specifically, as illustrated in FIG. 7, a magnetic brush 60e by the magnetic lines of force is formed in the developer layer 60 at the developing position T0, and a magnetic brush 60f by the magnetic lines of force is formed in the developer layer 60 at the position facing the seal roll 51. The magnetic brushes 60e and 60f contain the carrier of the developer layer 60.

The magnetic brush 60f stands up to overlap a dashed line 64 connecting a center 334C of the developing roll 334 and the center 51a of the seal roll 51. In more detail, the above-mentioned N pole 62 of the developing roll 334 is arranged toward the center 51a of the seal roll 51.

The N pole 62 is a magnet for forming the magnetic brush 60f toward the center 51a of the seal roll 51. In other words, the magnet is arranged from the center 334C of the developing roll 334 toward the center 51a of the seal roll 51 such that the magnetic brush 60f from the developing roll 334 stands up. The direction of the magnetic brushes 60e and 60f is the direction of the magnetic lines of force.

In addition, the S poles 61 and 63, which are magnetic poles different from the N pole 62, are arranged on the upstream side and the downstream side of the N pole 62 of the developing roll 334. In other words, the N pole 62 is adjacent to the S poles 61 and 63. The magnetic brushes other than the magnetic brushes 60e and 60f are inclined in accordance with the magnetic field generated by such adjacent arrangement. The N pole 62 is an example of a magnet, and the S poles 61 and 63 are examples of different polarity magnets.

Note that the plurality of magnetic poles in the developing roll 334 are not limited to the above-mentioned arrangement of magnets, and other arrangements of magnets may be adopted.

Here, the tip of the magnetic brush 60f in the developer layer 60 moves faster than the part other than the tip, and has a high ability to collect the reverse electrode toner 60b during the contact with the seal roll 51. Therefore, even in a case where the reverse electrode toner 60b gathered around the position 60d of the electrode member 52 due to the electric field formed by the electrode adheres to the seal roll 51, the sliding force of the magnetic brush 60f with the developer is increased, and the reverse electrode toner 60b is collected in the developer layer 60.

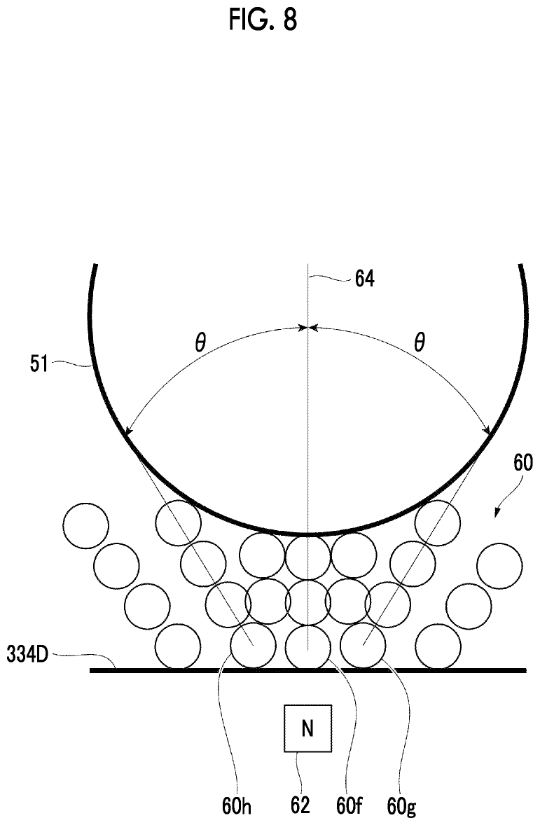

In more detail, since the magnetic brush 60f and magnetic brushes 60g and 60h (refer to FIG. 8) stand along the direction of the magnetic lines of force, it is not necessary to increase the positioning accuracy of the seal roll 51 with respect to the developing roll 334. That is, even in a case where the error in the distance between the developing roll 334 and the seal roll 51 is set to a large value, it is possible to collect the reverse electrode toner 60b that has adhered to the seal roll 51.

FIG. 8 is a diagram illustrating the magnetic brush of the developer layer 60 held by the developing roll 334. Note that, in FIG. 8, a normal line 334D of the developing roll 334 is illustrated instead of the outer circumferential surface of the developing roll 334 for convenience of calculating the magnetic lines of force. The normal line 334D intersects the line 64 (refer to FIG. 7).

In a contact state in which the developer layer 60 comes into contact with the seal roll 51, for example, as illustrated in FIG. 8, it is preferable that the magnetic brushes 60f, 60g, and 60h are positioned within a range of a predetermined angle θ with respect to the line 64. More specifically, the angle θ is 30 degrees in the present exemplary embodiment, the magnetic brush 60g is inclined by 30 degrees to the upstream side with respect to the line 64, and the magnetic brush 60h is inclined by 30 degrees to the downstream side with respect to the line 64. The angle θ is determined by various boundary conditions and is an example of a predetermined angle.

As illustrated in FIG. 8, the developer in the developer layer 60 comes into contact with the seal roll 51 within a range in which each of the magnetic brushes 60g and 60h on the upstream side and the downstream side has the angle θ (30 degrees in the present exemplary embodiment) with respect to the line 64.

In such a contact state, since the density of the magnetic brush tip is high, the reverse electrode toner 60b (refer to FIG. 7) on the surface of the seal roll 51 is rubbed and the cleaning effect is enhanced.

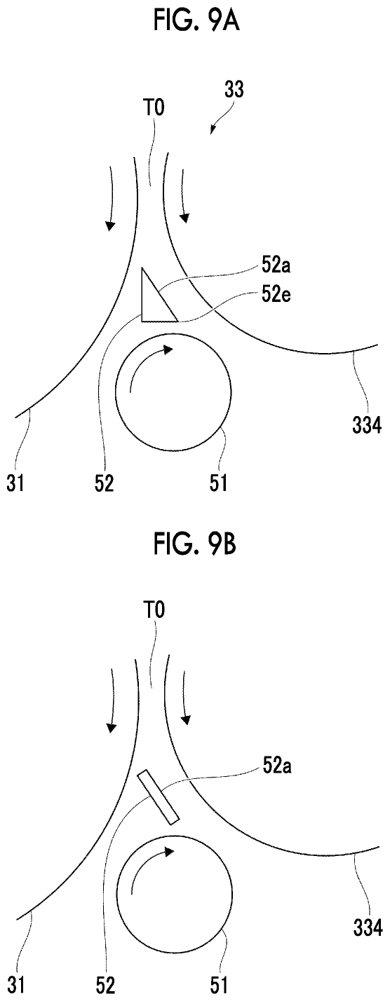

FIGS. 9A and 9B are diagrams illustrating modification examples of the electrode member 52 according to the first exemplary embodiment, FIG. 9A is one modification example, and FIG. 9B is another modification example.

In one modification example illustrated in FIG. 9A, the electrode member 52 has a triangular shape, and unlike the first exemplary embodiment (refer to FIGS. 3A to 3C), no notch is formed at the corner 52e. As in the other modification example, the electrode member 52 has the surface 52a facing the developing roll 334.

In the other modification example illustrated in FIG. 9B, the electrode member 52 has plate shape, and has a rectangular cross section. Also in the other modification example, the electrode member 52 has the surface 52a facing the developing roll 334.

FIG. 10 is a diagram illustrating the developing device 33 according to a second exemplary embodiment, and corresponds to FIG. 6 among FIGS. 3A to 9B illustrating the first exemplary embodiment. Therefore, the description of parts common to FIG. 6 may be omitted.

As illustrated in FIG. 10, in the second exemplary embodiment, the carrier collection roll 53 as an example of the first member is provided. More specifically, the developing device 33 according to the second exemplary embodiment does not include the seal roll 51 (for example, refer to FIGS. 3A to 3C) included in the developing device 33 according to the first exemplary embodiment, and the carrier collection roll 53 is arranged at the position of the seal roll 51.

Note that in the description of the first exemplary embodiment, the seal roll 51 can be replaced with the carrier collection roll 53. The carrier collection roll 53 is an example of the first member.

The carrier collection roll 53 is provided with a sleeve 53A that is configured by a cylindrical body and is rotationally driven, and with a magnet roll 53B arranged on the inner side of the sleeve 53A.

The magnet roll 53B of the carrier collection roll 53 is provided with a plurality of magnetic poles arranged along the circumferential direction. More specifically, the magnet roll 53B is provided with, as the plurality of magnetic poles, for example, an S pole 65 at a location where the developer layer 60 comes into contact with the sleeve 53A, and a N pole 66 on the upstream side of the location facing the electrode member 52. Further, the magnet roll 53B is provided with, as the plurality of magnetic poles, an S pole 67 at a position shifted by 180 degrees from the location where the developer layer 60 comes into contact with the sleeve 53A.

Here, in the second exemplary embodiment illustrated in FIG. 10, a case will be described in which reverse electrode toner 60i moves toward the outside of the device due to the airflow passing through the gap 82.

Since the reverse electrode toner 60i is positively charged, the reverse electrode toner 60i is easily drawn to the N pole 66 of the carrier collection roll 53. Therefore, in a case where the reverse electrode toner 60i adheres to the circumferential surface of the sleeve 53A, the reverse electrode toner 60i is collected into the developer layer 60 by the rotation of the sleeve 53A.

### Supplementary Note

(((1)))

A developing device comprising:
a developer holder that holds a developer containing toner and carrier and being supplied to an image holder forming an electrostatic latent image;
a first member that is provided on a downstream side of a developing position that is a position where the developer held by the developer holder is supplied to the image holder; and
a second member that is provided between the developer holder, the image holder, and the first member, that has a surface facing the developer holder, and to which an intermediate potential as a potential between a potential applied to the developer holder and a potential applied to the first member is applied.
(((2)))

The developing device according to (((1))),
wherein the developer holder has a magnet for forming a brush containing the carrier of the developer, toward a center direction of the first member.
(((3)))

The developing device according to (((2))),
wherein the magnet is adjacent to different polarity magnets, which have magnetic poles different from the magnet and are arranged on an upstream side and a downstream side of the magnet in the developer holder.
(((4)))

The developing device according to (((2))),
wherein in a case where reverse polarity toner drawn to the second member is collected by the developer that comes into contact with the first member on the downstream side of the position where the developer of the developer holder is supplied, the developer comes into contact with the first member in a range in which, among brushes, each of the brushes on the upstream side and the downstream side has a predetermined angle with respect to the center direction.
(((5)))

The developing device according to (((1))),
wherein the intermediate potential of the second member is set such that, among a distance between the second member and the developer holder and a distance between the second member and the first member, a potential difference of the shorter distance is smaller than a potential difference of the far distance.
(((6)))

The developing device according to (((5))),
wherein the setting is performed according to a ratio of the distance between the second member and the developer holder and the distance between the second member and the first member.
(((7)))

The developing device according to any one of (((1))) to (((6))),
wherein the second member has a polygonal shape having the surface as a slope.
(((8)))

The developing device according to (((7))),
wherein the polygonal shape has a surface facing the developer holder at a position adjacent to the first member.
(((9))

The developing device according to (((8))),
wherein the surface facing the developer holder extends in a center direction of the first member.
(((10)))

The developing device according to any one of (((7))) to ((9)
wherein the slope is provided in a tangential direction of the developer holder such that a distance from the developer holder is not changed from one end portion to the other end portion of the slope.
(((11))

An image forming apparatus comprising:
an image holder that forms an electrostatic latent image;
a developing section that develops the electrostatic latent image formed on the image holder into a toner image;
a transfer section that transfers the toner image by the developing section onto a recording material; and
a fixing section that fixes the toner image transferred onto the recording material to the recording material,
wherein the developing section includes
a developer holder that holds a developer containing toner and carrier and being supplied to the image holder forming the electrostatic latent image,
a first member that is provided on a downstream side of a developing position that is a position where the developer held by the developer holder is supplied to the image holder, and
a second member that is provided between the developer holder, the image holder, and the first member, that has a surface facing the developer holder, and to which an intermediate potential as a potential between a potential applied to the developer holder and a potential applied to the first member is applied.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device comprising:
a developer holder that holds a developer containing toner and carrier and being supplied to an image holder forming an electrostatic latent image;
a first member that is provided on a downstream side of a developing position that is a position where the developer held by the developer holder is supplied to the image holder; and
a second member that is provided between the developer holder, the image holder, and the first member, that has a surface facing the developer holder, and to which an intermediate potential as a potential between a potential applied to the developer holder and a potential applied to the first member is applied.

2. The developing device according to claim 1,
wherein the developer holder has a magnet for forming a brush containing the carrier of the developer, toward a center direction of the first member.

3. The developing device according to claim 2,
wherein the magnet is adjacent to different polarity magnets, which have magnetic poles different from the magnet and are arranged on an upstream side and a downstream side of the magnet in the developer holder.

4. The developing device according to claim 2,
wherein in a case where reverse polarity toner drawn to the second member is collected by the developer that comes into contact with the first member on the downstream side of the position where the developer of the developer holder is supplied, the developer comes into contact with the first member in a range in which, among brushes, each of the brushes on the upstream side and the downstream side has a predetermined angle with respect to the center direction.

5. The developing device according to claim 1,
wherein the intermediate potential of the second member is set such that, among a distance between the second member and the developer holder and a distance between the second member and the first member, a potential difference of the shorter distance is smaller than a potential difference of the far distance.

6. The developing device according to claim 5,
wherein the setting is performed according to a ratio of the distance between the second member and the developer holder and the distance between the second member and the first member.

7. The developing device according to claim 1,
wherein the second member has a polygonal shape having the surface as a slope.

8. The developing device according to claim 7,
wherein the polygonal shape has a surface facing the developer holder at a position adjacent to the first member.

9. The developing device according to claim 8,
wherein the surface facing the developer holder extends in a center direction of the first member.

10. The developing device according to claim 7,
wherein the slope is provided in a tangential direction of the developer holder such that a distance from the developer holder is not changed from one end portion to the other end portion of the slope.

11. An image forming apparatus comprising:
an image holder that forms an electrostatic latent image;
a developing section that develops the electrostatic latent image formed on the image holder into a toner image;
a transfer section that transfers the toner image by the developing section onto a recording material; and
a fixing section that fixes the toner image transferred onto the recording material to the recording material,
wherein the developing section includes
a developer holder that holds a developer containing toner and carrier and being supplied to the image holder forming the electrostatic latent image,
a first member that is provided on a downstream side of a developing position that is a position where the developer held by the developer holder is supplied to the image holder, and
a second member that is provided between the developer holder, the image holder, and the first member, that has a surface facing the developer holder, and to which an intermediate potential as a potential between a potential applied to the developer holder and a potential applied to the first member is applied.
